(19) United States
(12) Patent Application Publication
(10) Pub. No.: US 2009/0313867 A1
(43) Pub. Date: Dec. 24, 2009

(54) Scrolling Display

(76) Inventors: Israel Levy, Toronto (CA); Jay Klein, Concord (CA); Robert Kapronczai, Willow Beach (CA)

Correspondence Address: GEORGE S. LEVY, 3980 DEL MAR MEADOWS, SAN DIEGO, CA, 92130, US

(21) Appl. No.: 12/472,835

(22) Filed: May 27, 2009

Related U.S. Application Data
(60) Provisional application No. 61/073,726, filed on Jun. 18, 2008.
(60) Provisional application No. 61/090,886, filed on Aug. 21, 2008.

(51) Int. Cl. G09F 11/22; G09F 11/21

(52) U.S. Cl. 40/471

(57) ABSTRACT

A scrolling display system suitable for large public gatherings. This display comprises at least one display element itself comprising: a frame comprising a display window; two horizontal and parallel end rollers affixed by their extremities to the frame; a rectangular sheet of fabric carrying illustrations and having its ends wound around the end rollers; at least one horizontal guiding roller affixed to the frame and positioned to guide the fabric sheet and fold its path between the two end rollers; at least one horizontal weight roller positioned to maintain tension on the fabric; a programmable electrical motor configured to produce a predetermined amount of angular displacement; driving belts connecting the motor to the end rollers, to transmit the angular displacement to the end rollers. Display of desired illustration is achieved by scrolling the fabric sheet until the illustration faces the display window.

### FIELD OF THE INVENTION

This invention claims the benefit of U.S. Provisional Application No. 61/073,726 filed on Jun. 18, 2008 and U.S. Provisional Application No. 61/090,886 filed on Aug. 21, 2008, both entitled, “Scrolling Display” and which are hereby incorporated by reference. Applicant claims priority pursuant to 35 U.S.C. Par 119(e)(i). The present invention relates to large displays, typically displays in which fabric sheets are scrolled between two rollers.

### BACKGROUND

Very large modern displays utilize expensive electronic and optical technology. There is a need for inexpensive displays that can be scaled up in sport games and other such public gatherings. Previous art describes scrolling displays making use of fabric sheets scrolled between two rollers. Inherent in such scrolling displays is the following problem: if the winding roller and the unwinding roller contain different amounts of fabric, their diameter will be different and, therefore, for an equal angular displacement of the rollers, the linear displacement of the fabric sheet produced by each roller will be different. This difference in linear displacement results either in the loss of tension and bunching of the fabric, or in the tearing of the fabric because of the high tension. Prior art makes use of break systems, clutches, spring or torsion springs to compensate for the differences in the rate of movement of the fabric from one roll to another.

Prior art approaches are complicated and unreliable, especially when the display is very large. None of the prior art offers the economy, reliability and usefulness of this invention. Further features, aspects, and advantages of the present invention over the prior art will be more fully understood when considered with respect to the following detailed description claims and accompanying drawings.

### BRIEF DESCRIPTION OF THE DRAWINGS

FIG. 1 illustrates the display without the end panels and foam pads to allow the internal mechanism to be visible from the sides.

FIG. 2 illustrates the display without the fabric sheet to allow the internal mechanism to be visible.

FIG. 3 shows the display as it would appear to a viewer. Frame and sides covered with foam pads.

FIG. 4 illustrates a one sided display without the side panels. In this illustration the front side of the display is shown.

FIG. 4A illustrates a one sided display without the side panels. In this illustration the back side of the display is shown.

FIG. 4B illustrates a one sided display with the side panels. In this illustration the back side of the display is shown with the back panel.

FIG. 4C illustrates a one sided display with the side panels. In this illustration the front panel the display is shown.

FIG. 5 shows how the rollers are mounted on the frame and connected to each other by means of belts.

FIG. 5A shows that the tubular motors are thin enough to fit inside and end roller.

FIG. 6 shows how displays can be chained to form a composite display.

FIG. 7 is a block diagram illustrating the operation of the motor by means of a remote controller.

FIG. 8 provides a modular illustration of the display system which comprises the remote, the controller, the motor, the rotation encoder and the display roll.

FIG. 9 illustrates the sequence of actions performed by the remote which includes the entry of the desired image ID and the transmission of this ID to the controller.

FIG. 10 is a block diagram illustrating the operation of the controller. The required image ID is received and converted to rotational units. The position of the motor is measured by the rotational encoder. The current motor position and the desired position are compared and the difference is used to control the motor.

FIG. 11 is a block diagram illustrating how this device can be controlled over the Internet.

### SUMMARY OF THE INVENTION

This invention is a scrolling display system comprised of at least one display element and is suitable to be used in large public gatherings. Each display element comprises a fabric sheet which is imprinted with images and/or text. Display of different images is achieved by scrolling the sheet between two horizontal end rollers: the sheet is wound at one of its end around the first end roller. The sheet is then exposed to view through a window thereby exposing its graphical material. The sheet is then guided through a folded path between a number of guide rollers and weight rollers. Finally the sheet reaches and is wound around the second end roller. The combination of guide rollers and weight roller compensates for the unequal linear displacement produced by the end rollers. The invention includes a two sided version in which the frame comprises a display window on each one of its sides. It also includes a one sided version in which a single window is provided on one side. A programmable motor is used to shift the fabric from one image or text message to another. The display system can be controlled by a remote controller. It can also be controlled over the internet by assigning a web address to the motor controller. Arrays of such display elements can be appended back to back and end to end and synchronized to produce very long one sided or two sided display systems.

### DETAILED DESCRIPTION

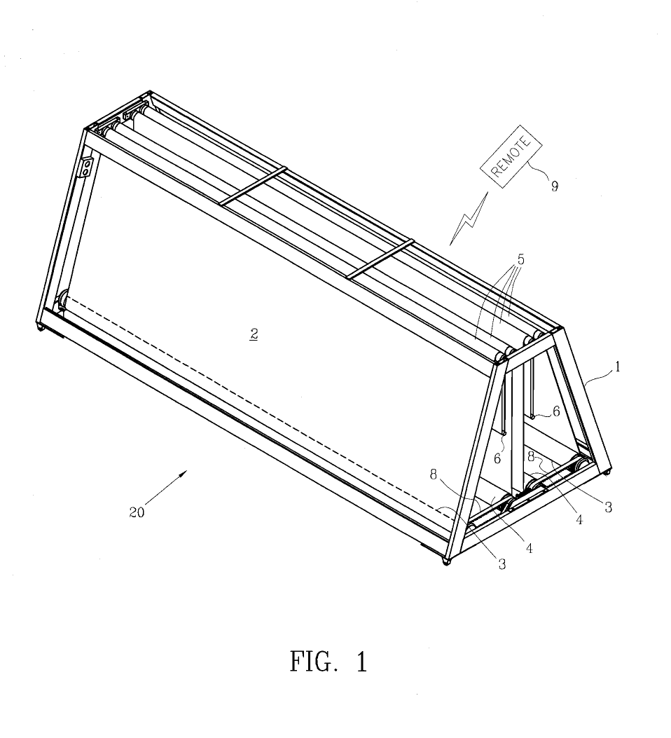

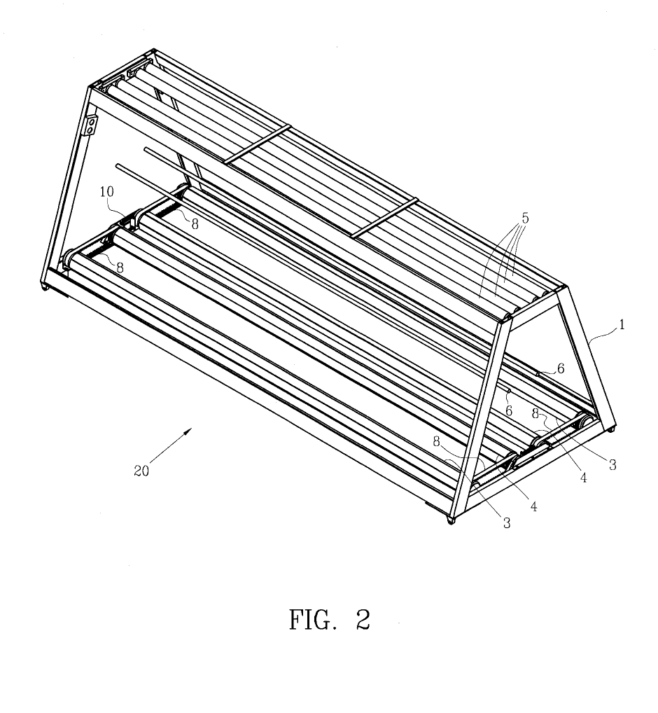

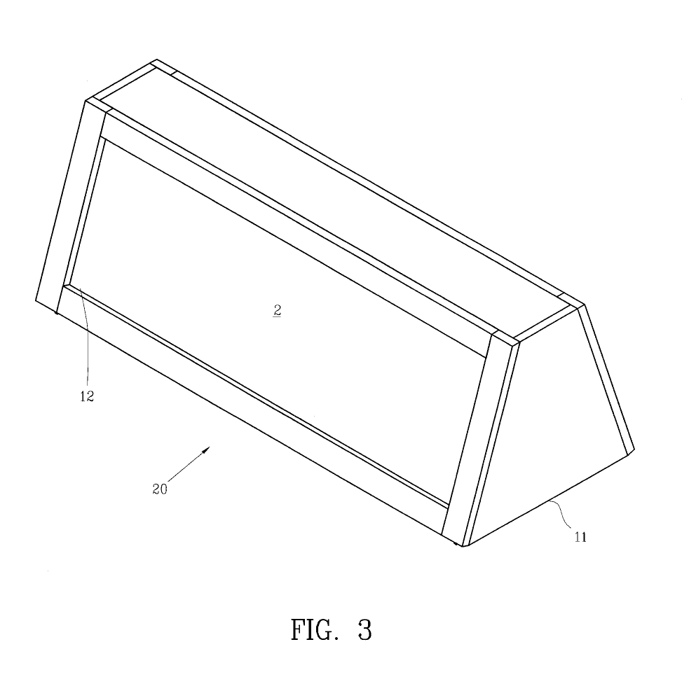

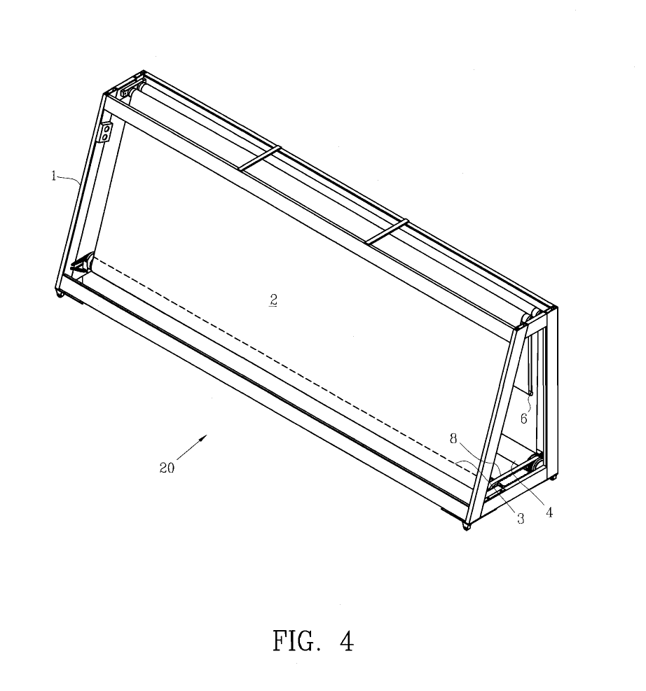

This invention is a display system comprising at least one scrolling display element suitable to be used in large public gatherings such as sport games. A display element is illustrated in FIG. 1, FIG. 2 and FIG. 3. Essentially, each display element comprises the following:
a) At least one long rectangular sheet 2 (or large ribbon) of fabric or such flexible material carrying illustrations to be displayed in the form of images or text. The illustrations are separated and clearly delimited by blank intervals
b) A frame 1 wider at its base than at its top to provide stability. The frame includes at least one window 12 through which a portion of the sheet can be displayed.
c) At least one pair of horizontal end rollers 3 and 4, each end roller having wound around itself one end of the fabric sheet 2.
d) A number of horizontal guiding 5 rollers that allow the fabric sheet 2 between the two end rollers 3 and 4 to be maneuvered inside the frame 1.
e) At least one horizontal weight rollers 6 used to maintain tension on the fabric.
f) A programmable electrical motor 7 capable of performing a programmable number of rotations or partial rotations, each rotation or partial rotation being defined by its corresponding angular displacement.
g) Driving belts 8 connecting the motor 7 to the end rollers 3 and 4, imparting to each end roller essentially equal angular displacement.
h) A remote control 9 allowing the user to control the operation of the motor 7 from a distance.
i) End panels 11.

As illustrated in FIG. 3 the display of an image is achieved by positioning the desired graphics on the sheet 2 against the display window 12 on the frame 1. This is done by scrolling the sheet 2 between the two end rollers 3 and 4 until the desired sheet position is achieved.

As is evident to one versed in the art, for an equal amount of angular displacement of two end rollers 3 and 4, the amount of linear displacement of the fabric 2 is different depending on the amount of fabric wound onto each roller 3 and 4. A large amount of fabric on a roller results in a large diameter of the roller and therefore in a large linear displacement of the fabric. And vice versa, a small amount of fabric on a roller results in a small diameter of the roller and therefore in a small linear displacement of the fabric. Unless a solution is provided to the problem of unequal linear displacement, the fabric will either bunch up between the two rollers 3 and 4 or break because of the tension.

This invention solves the problem of unequal linear displacement of the fabric by means of guide bars or rollers 5 and weight bars or rollers 6 inserted between the two end rollers 3 and 4. This arrangement ensures that tension is always present in the fabric 2. The figures show only one weight roller 6 and two guide rollers between two end rollers 3 and 4. It is evident that additional guide and weight rollers or bars could be added to allow for a greater difference in linear displacement between the rollers. The greater the number of guide bars and weight bars, the larger the difference in linear displacement that can be accommodated.

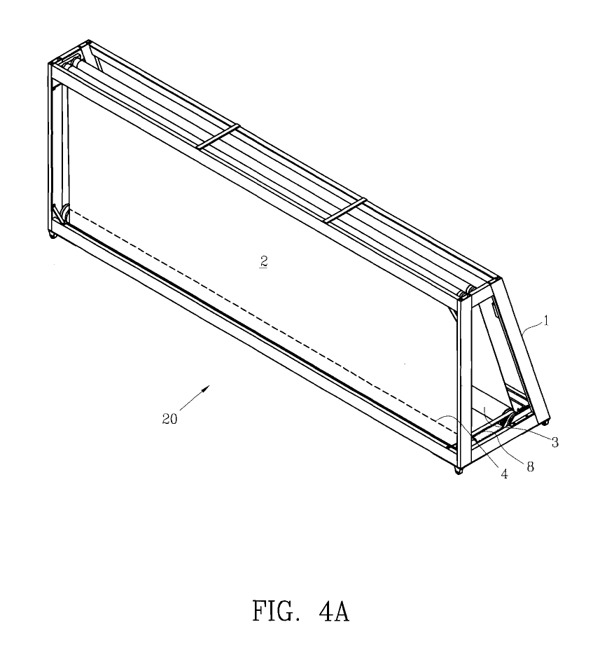

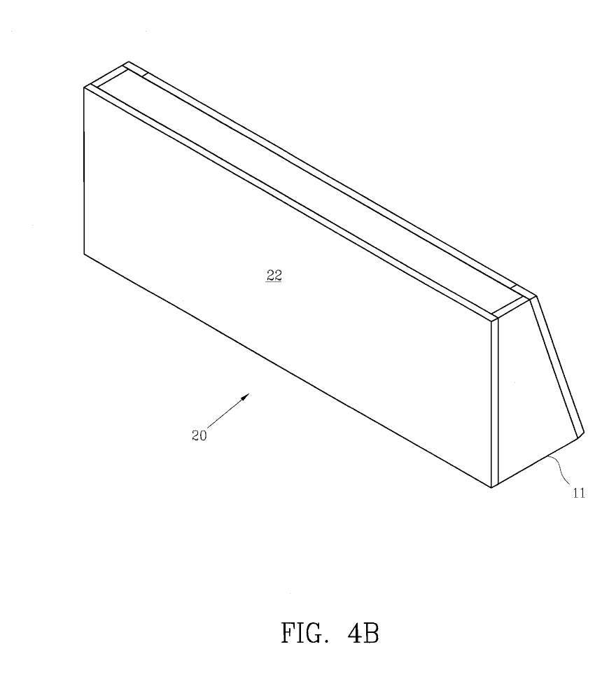

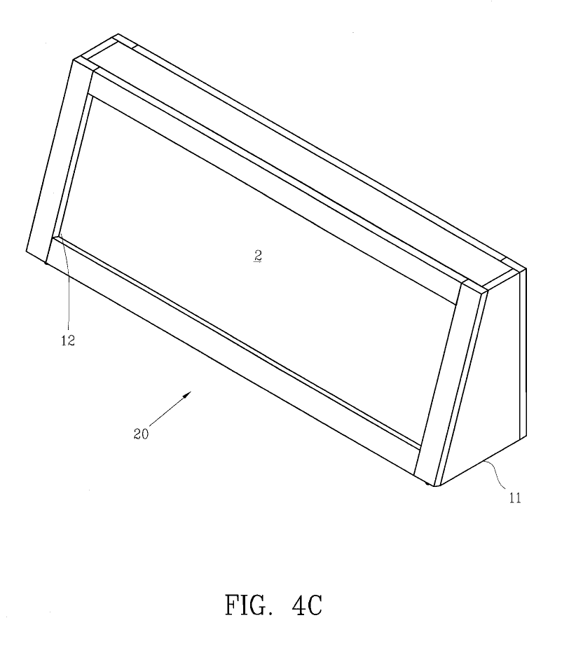

The frame 1 can be configured to provide a one-sided display system or a two sided display system. The one sided version is shown without a cover in FIG. 4 (front side), and FIG. 4A (back side) and with a cover in FIG. 4C (front side) and FIG. 4B (back side). The back side of a one sided display can be covered with a stationary panel 22 which itself can carry some visual information in the form of pictorial or text data, to provide additional display utility. This version requires a single motor.

As is shown in FIG. 4, FIG. 4A, FIG. 4B and FIG. 4C, the front side of the display is shown as being slanted with respect the vertical and the back side is shown as being vertical. As an option, it is possible to have the reverse configuration in which the front side is vertical and the back side is at a slant with respect the vertical. Essentially this requires the window 12 to be configured in the vertical part of the frame 1 and the display panel 22 to be mounted on the slanted part of the frame 1.

The two sided version is shown in FIG. 1, FIG. 2 (without a cover) and in FIG. 3 (with a cover). In the two sided display configuration, each side of the display can be driven independently by its own independent motor.

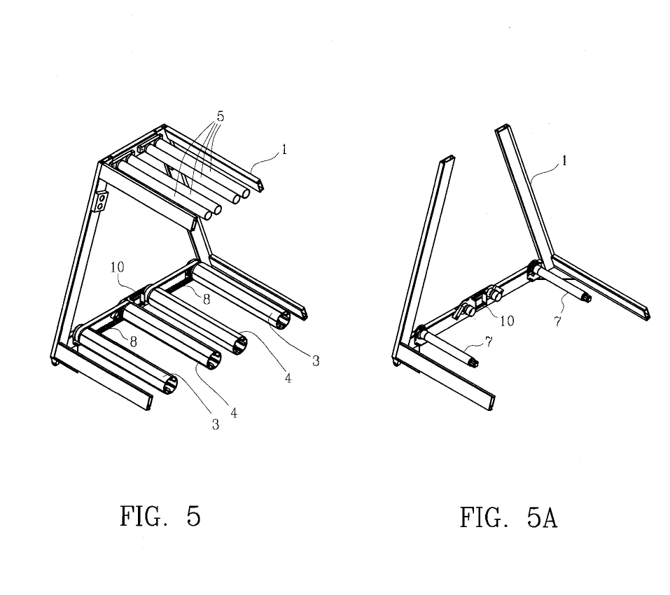

FIG. 5 illustrates the end of the frame that supports the rollers. A belt 8 is used to connect the end rollers 3 and 4 to ensure that their rotations are coordinated.

FIG. 5A shows the motors 7 which are thin enough to be inserted inside the end rollers 3 and 4.

As illustrated in FIG. 2, FIG. 5 and FIG. 5A, the rollers 4 are mounted on the frame by means of supporting brackets which are free to slide back and forward with respect to the frame. Springs 10 attached at one end to these sliding supporting brackets and at the other end to the frame, apply tension to the driving belts 8 looping around the motorized rollers 3 and the driven rollers 4.

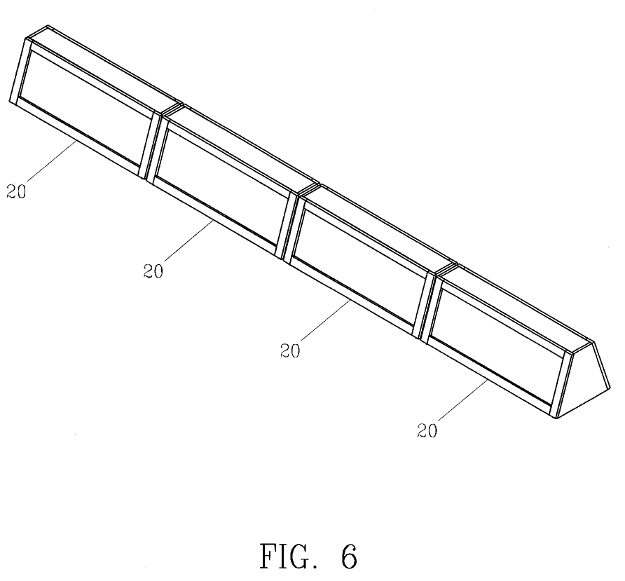

A composite display system can be formed as illustrated in FIG. 6 by positioning several display elements 20 side by side, each display element 20 having its own motor 7. Since the operation of the motors is programmable, the motors' angular displacement in each display element 20 in the composite can be made synchronous and the individual displays 20 therefore can operate together to form a large composite display. The display elements can be arranged back to back or can be appended linearly or both.

The use of weight bars or rollers 6 and guide bars or rollers 5 instead of break systems, clutches or torsion springs makes the operation of this invention very reliable and eminently suitable for the construction of very large display structures.

The display 20 is clearly portable as it can easily fit a truck and can operate from batteries or electrical generators to accommodate locations without easy access to electricity.

This simplified structure is much more reliable for very large scrolls of fabric. For example a prototype has been built that can store 90 feet in length of scrolled fabric with a width of up to 10 feet. It would be easy for someone versed in the art to construct larger or smaller such display devices.

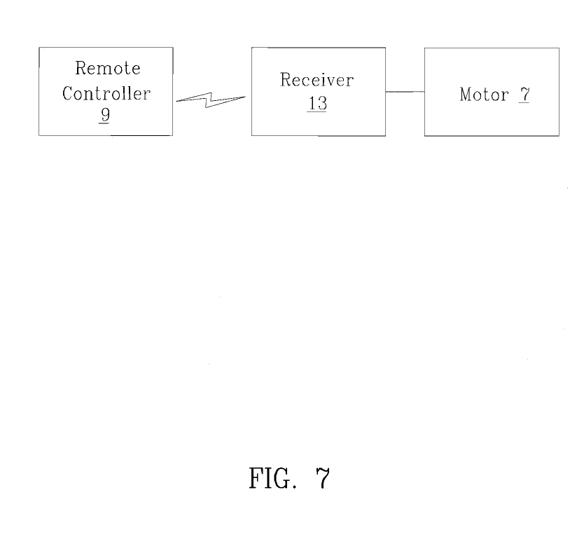

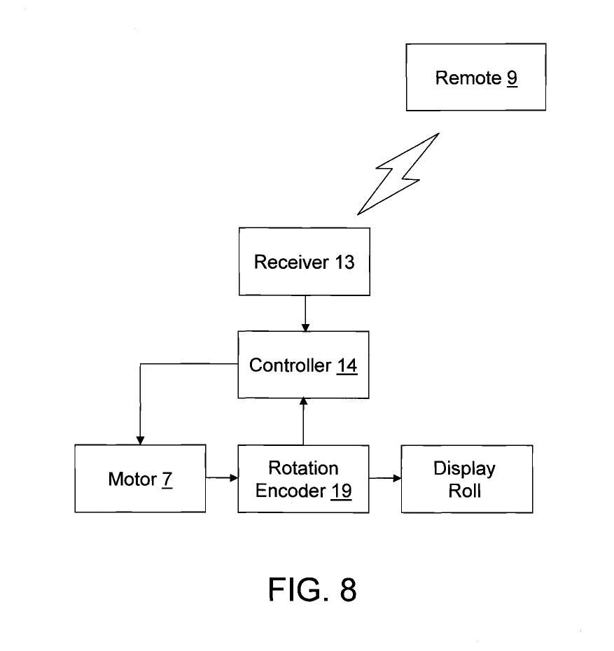

As shown in FIG. 7 and FIG. 8 the motor driving the end rollers can, as an option, be activated by means of a remote controller 9. When a wireless control signal is sent by the remote 9, it is received by a receiver 13 located on the display. An electrical signal is then sent through a wire to the motor controller 14 that controls the operation of the motor 7. A rotational encoder measures the position of the motor axle or of the display roll 3 or 4 and sends this information to the motor controller. The shape of the motor 7 is tubular and is configured to fit inside an end roller 3 or 4. The motor that was used in building a prototype is manufactured by Somfy Systems, Inc., and was originally designed to drive window blinds.

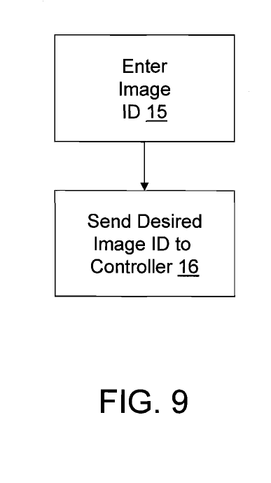

FIG. 9 illustrates the sequence of actions performed by the remote which includes the entry 15 of the desired image ID by the operator of the display, and the transmission 16 of this ID to the motor controller 14.

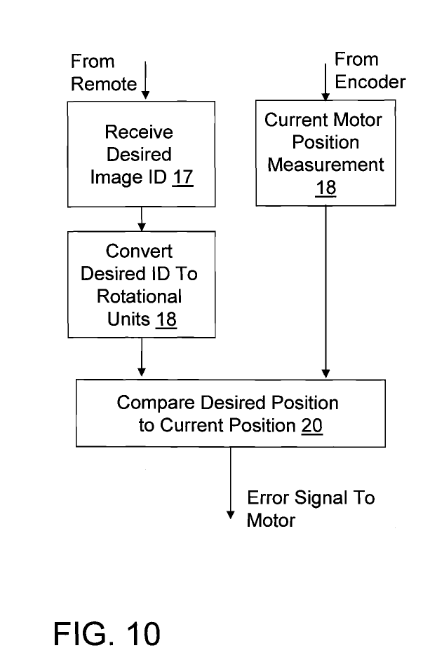

FIG. 10 is a block diagram illustrating the operation of the receiver 13 and motor controller 14. The required image ID is received 17 and converted 18 to rotational units. The position of the motor is measured 18 by the rotational encoder 19. The current motor position and the desired position are compared 20 and the difference is used to control the motor 7.

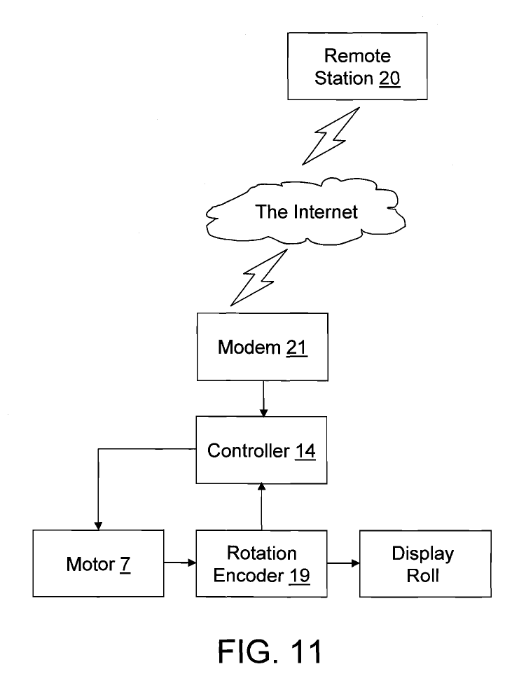

The communication between the remote controller and the motor controller can be implemented in many different ways. As illustrated in FIG. 11 the communication between the operator located at a remote station 20 and the device can be performed over the Internet by assigning an internet addresses to the motor controller 14 by providing internet interface software such as a modem 21.

Power can be provided to the motor by means of a battery or power generator thus allowing the operation of the device in location where there is no readily available electrical outlet.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A scrolling display system suitable to be used in large public gatherings comprising at least one display element, each said display element comprising:
a) a frame comprising at least one display window;
b) two essentially horizontal and essentially parallel end rollers rotatably affixed by their extremities to said frame;
c) a rectangular sheet of flexible material carrying on its surface at least two illustrations comprising images or text, said illustrations having on said fabric sheet, a position separated by illustration intervals, opposite ends of said fabric sheet being wound around said end rollers;
d) at least one essentially horizontal guiding roller, its extremities rotatably affixed to said frame and essentially parallel to said end rollers, said guiding rollers positioned to guide said fabric sheet and fold its path between said two end rollers;
e) at least one essentially horizontal weight roller positioned to maintain tension on said fabric;
f) a programmable electrical motor affixed to said frame and configured to produce a predetermined angular displacement, said electrical motor being mechanically coupled to one of said end rollers; and
g) at least one driving belt connecting said end rollers;
whereby the display of one particular of said illustrations being achieved by scrolling said sheet until said particular illustration faces said display window.

2. The display system of claim 1 wherein the extremities of said weight roller are rotatably and slidably affixed to said frame.

3. The display system of claim 1 wherein said belt is configured such that the angular displacement of said end rollers remains essentially equal, and also equal to said illustration interval.

4. The display system of claim 1 wherein each display element has a back side and a front side, and furthermore wherein each display element comprises only one said display window on said front side.

5. The display system of claim 4 wherein each said display element also comprises a fixed panel on said back side wherein said fixed panel carries visual information in the form of pictorial or text data.

6. The display system of claim 4 comprising only one said display element.

7. A display system of claim 4 wherein each said display element is elongated in the direction of the axis of said rollers and is adapted to be joined end to end to other display elements.

8. The display array of claim 4 wherein each said array element is controlled synchronously thereby ensuring that the images displayed by each said array element are coordinated to each other.

9. A display system of claim 4 wherein said display elements are paired and arranged back to back in pair such that said back side of said first display element in a given pair abuts said back side of second display element in said given pair.

10. A display system of claim 9 comprising only two said display elements.

11. A display system of claim 9 wherein each said display element in a pair is elongated in the direction of the axis of said rollers and is adapted to be joined end to end to the corresponding said display elements in another given pair.

12. The display array of claim 9 wherein each said array element is controlled synchronously thereby ensuring that the images displayed by each said array element are coordinated to each other.

13. The display of claim 1 wherein said motor is tubular and configured to fit inside one of said end rollers.

14. The display of claim 1 wherein said driving belt is kept under tension by means of a spring.

15. The display of claim 1 wherein said programmable motor comprises a motor controller.

16. The display of claim 15 also comprising a remote control unit wirelessly connected to said motor controller, thereby allowing said programmable motor to be controlled wirelessly.

17. The display of claim 15 wherein said motor controller is assigned an internet address and provided with an internet interface, thereby allowing operation of said display over the internet.

18. The display of claim 1 also comprising of an electrical generator connected to provide electrical power to said motor.

19. The display of claim 1 also comprising of a battery connected to provide electrical power to said motor.
